(19) United States
(12) Patent Application Publication
(10) Pub. No.: US 2021/0034826 A1
(43) Pub. Date: Feb. 4, 2021

(54) METHOD OF CHECKING PRODUCTS

(71) Applicant: Rong-Der Hong, Taichung City (TW)

(72) Inventors: Rong-Der Hong, Taichung City (TW); Chien-Hung Lee, Taichung City (TW)

(73) Assignee: Rong-Der Hong, Taichung City (TW)

(21) Appl. No.: 16/527,621

(22) Filed: Jul. 31, 2019

(51) Int. Cl. G06K 7/10

(52) U.S. Cl. CPC G06K 7/10128; G06K 7/10138; G06K 7/10099

(57) ABSTRACT

A method of checking products is provided, which includes the following steps. The electronic device reads an electronic tag on an object by the tag reading module so as to obtain an object identification code which is corresponding to and provided on the electronic tag; the electronic device transmits the object identification code to a data management system; the data management system searches from the database whether an identification code of the product items is consistent with the object identification code; if the consistent identification code is not found, the data management system transmits a notification message to the electronic device whereby workers can be informed by the electronic device that the current object doesn't belong to the products corresponding to the product items so that it would be more convenient to check products.

### BACKGROUND OF THE INVENTION

### 1. Technical Field

The present invention relates generally to checking products, and more particularly to a method of checking products.

### 2. Description of Related Art

Mostly, for managing various products, the product producer or owner will record the basic information of the products. For companies managing considerable products, the basic information of each product is further filed to be easily managed or maintained.

However, when an average user sees an object among products, the user usually judges by the appearance of the object whether the object belongs to the products, which may result in an error of judgement.

To identify products easily for users, tags would be provided on products for recognizing. Nevertheless, if the tag falls off, it would be also difficult for users to know if the object belongs to the products.

Take the management of hanging devices as an example, which include hooks, buckles, carabiners, and fall arresters, to stay safe, users must know exactly if the devices they take are the correct hanging devices. If a part of hanging devices has not been filed, users may work with the unfiled hanging devices, which increases risks.

### BRIEF SUMMARY OF THE INVENTION

In view of the above, the primary objective of the present invention is to provide a method of checking products so that it would be more convenient to check products.

The present invention provides a method of checking products, which is applied to a data management system. The data management system includes a database storing a plurality of product items corresponding to a plurality of products. Each of the product items correspondingly has an identification code, and the identification code is corresponding to one of the products. The method includes the following steps.

A. provide an electronic device which is connected to the data management system, wherein the electronic device includes a tag reading module; the electronic device reads at least an electronic tag on at least an object by the tag reading module so as to obtain an object identification code which is corresponding to and provided on the electronic tag;

B. after obtaining the object identification code, the electronic device transmits the object identification code to the data management system;

C. according to the received object identification code, the data management system searches from the database whether an identification code of the product items is consistent with the object identification code; and

D. if the identification code which is consistent with the object identification code is not found, the data management system transmits a notification message to the electronic device.

By the abovementioned steps, if the consistent identification code is not found, transmit the notification message to the electronic device so that workers will know that the current object doesn't belong to any of the products. Thereby, it would be more convenient to check products.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of the data management system and the connection structure thereof, to which the first preferred embodiment of the present invention is applied;

FIG. 2 is a schematic diagram of the content of the database of the first preferred embodiment;

FIG. 3 is a flow chart of the first preferred embodiment of the present invention;

FIG. 4 is a schematic diagram of the content of the database of the second preferred embodiment of the present invention;

FIG. 5 is a flow chart of the second preferred embodiment;

FIG. 6 is a schematic diagram of the content of the database of the third preferred embodiment of the present invention; and

FIG. 7 is a flow chart of the third preferred embodiment.

### DETAILED DESCRIPTION OF THE INVENTION

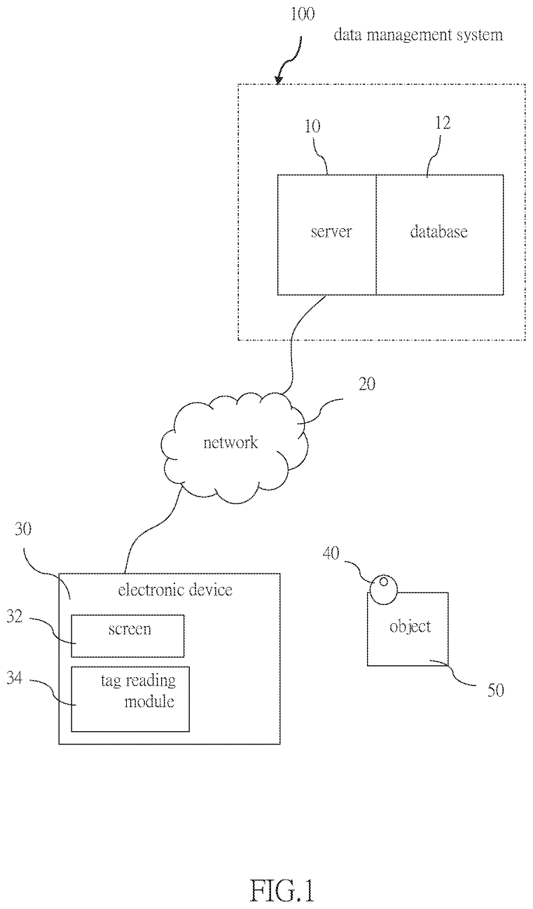

As shown in FIG. 1, a data management system 100 and the connection structure thereof, to which the first preferred embodiment of the present invention is applied, are illustrated. The data management system 100 includes a server 10 and a database 12, wherein the server 10 is connected to the database 12. The server 10 is connected to a network 20 in a wired or wireless manner

At least a user can take at least an electronic device 30 and connect the electronic device 30 to the server 10 through the network 20. The electronic device 30 could be a computer, smart phone, or tablet, which is a networkable equipment.

The electronic device 30 has a screen 32 and a tag reading module 34, wherein the screen 32 is provided for displaying data. The tag reading device 34 is provided for reading at least an electronic tag 40 in a contactless manner so as to obtain an object identification code which is contained in and corresponding to the electronic tag 40. The electronic tag 40 can be an RFID tag. The at least an electronic tag 40 is provided on at least an object 50; in practice, there can be a plurality of electronic tags 40 provided on a plurality of objects 50 respectively. The tag reading module 34 can read a single or multiple electronic tags 40 at a time.

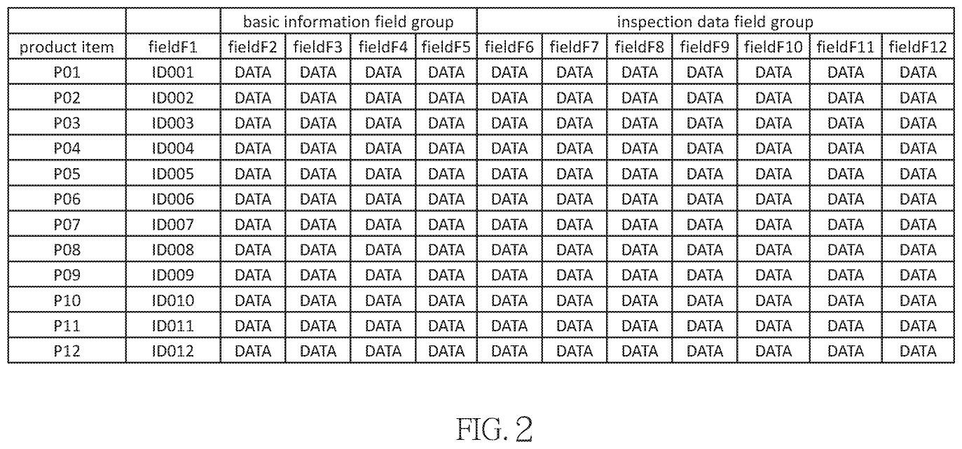

As shown in FIG. 2, the database 12 contains data from product items P01 to P12 which are corresponding to a plurality of products respectively. In this embodiment, the products are hanging devices such as hooks, buckles, carabiners, and fall arresters. An identification tag is provided on each of the products, wherein the identification tag is an electronic tag such as an RFID. Each of the identification tag contains an identification code correspondingly.

The server 10 is provided to process the data in the database 12. The product items are set in the database 12 by the owner of the products through the server 10. The data of each of the product items P01 to P12 contains a plurality of fields (field F1 to field F12) which include a basic information field group (field F1 to field F5) and an inspection data field group (field F6 to field F12). Furthermore, the basic information of the product items P01 to P12 are recorded in the basic information field group (field F1 to field F5). For example, field F1 is an identification code field which is provided for recording the identification code of the identification tag on the product; the product name is recorded in field F2; the product number is recorded in field F3; the product location information is recorded in field F4; the manager is recorded in field F5. The content recorded in field F1 is represented as “ID001” to “ID012”, and the content recorded in fields F2 to F5 are represented as “DATA”. By the identification code recorded in field F1, each identification tag can be corresponding to one of the product items P01 to P12 and one of the products.

The inspection data of product items are recorded in the inspection data field group (field F6 to field F12). For example, the scheduled inspection period of the product is recorded in field F6; the scheduled inspection period of different product items P01 to P12 can be the same or different; each of the scheduled inspection period has a start date and an expiration date, and the product can be used only if the product is inspected within the scheduled inspection period and qualified. The inspector is recorded in field F7; the inspection standard is recorded in field F8; the inspection date is recorded in field F9; the location information of the inspection location is recorded in field F10; the inspected part is recorded in field F11; the qualified status is recorded in field F12. Content recorded in fields F6 to F12 are represented as “DATA”.

The aforementioned field groups and the number of fields are only examples rather than limitations on the present invention. The database 12 shown in FIG. 1 of the first preferred embodiment is independent of the server 10. However, this is not a limitation on the present invention. In other words, the database 12 and the server 10 could be integrated into a host.

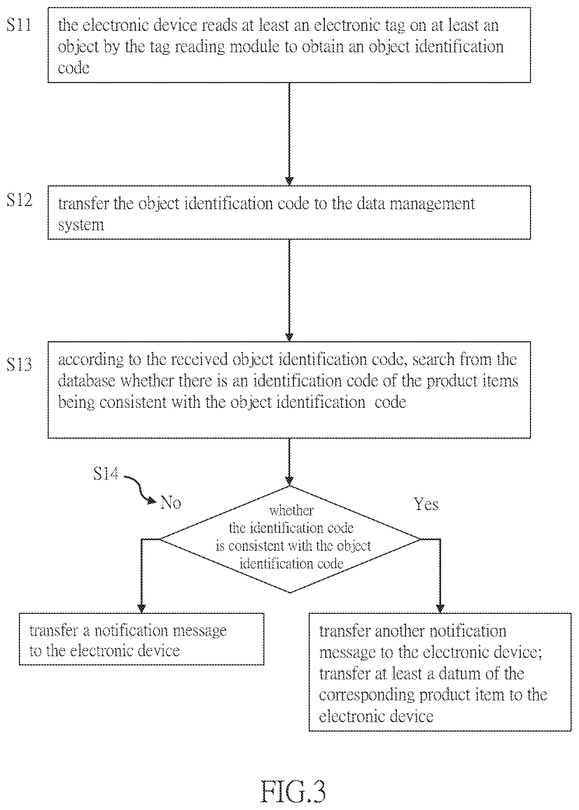

By the above structure, a method of checking products in this embodiment includes the following steps shown in FIG. 3.

Step S11: provide the electronic device 30 connected to the data management system 100, wherein the electronic device 30 reads at least an electronic tag 40 on an object 50 by the tag reading module 34 so as to obtain the corresponding object identification code which is contained by the electronic tag 40. In this embodiment, a worker operates the electronic device 30, e. g., runs an application, to start the tag reading module 34 thereof in order to read the electronic tag 40 on the object 50. Thus, the electronic device 30 can obtain the object identification code and store it.

Step S12: after obtaining the object identification code, the electronic device 30 transmits the object identification code to the data management system 100. In this embodiment, the electronic device 30 transmits the object identification code to the server 10 through the network.

Step S13: according to the received object identification code, the data management system 100 searches from the database 12 whether there is an identification code of the product items P01 to P12 being consistent with the object identification code. In this embodiment, after receiving the object identification code, the server 10 compares the object identification code with the content of the identification code field (field F1 ) of each of the product items in the database 12 to search for the consistent identification code.

Step S14: if no consistent identification code is found, the data management system 100 transmits a notification message to the electronic device 30. In this embodiment, after comparison and verifying that there is no identification code consistent with the object identification code, the server 10 generates the notification message and transmits the notification message to the electronic device 30 by the network 20. The notification message indicates that the object 50 doesn't belong to the products corresponding to the product items in the database. By this step, workers can be informed by the electronic device 30 that the current object 50 doesn't belong to the products of the product owner, which achieves the goal of checking products, for example, confirming if the object 50 is a counterfeit.

The abovementioned steps are the basic steps of the first preferred embodiment to accomplish the goal of checking products.

Moreover, after the electronic device 30 receives the notification message, the notification message can be displayed on the screen 32 of the electronic device 30. For example, the notification message can contain words such as “no such product” or “non-company product”. Additionally, the electronic device 30 can generate signals corresponding to the notification message like lights or sounds.

Furthermore, step S14 includes the following step. If there is an identification code consistent with the object, the server 10 can transmit another notification message to the electronic device 30 so as to inform workers that the object 50 belongs to the product corresponding to the product items in the database. The notification message can be words like “company product confirmed”. Practically, if the consistent identification code is found, the another notification message may also not be transmitted.

In addition, after the consistent identification code is found, the data management system 100 transmits at least a datum of the product items P01 to P12 which are corresponding to the identification code to the electronic device 30. In this embodiment, after finding the consistent identification code, the server 10 transmits the datum recorded in at least a field in the product items P01 to P12 to the electronic device 30 by the network 20 with a transmission rule that is preset. In the transmission rule, the product owner can select the data in one or multiple fields to be transmitted and store the transmission rule in the server 10 or the database 12, e. g., select the data in field F2(product name) and field F12 (qualified status).

For example, in step S12, the electronic device 30 obtains the object identification code “ID003”. Afterward, by steps S13 and S14, the server 10 finds the identification code “ID003” which is consistent with the object identification code “ID003” as well as the corresponding product item P03. The server 10 then follows the transmission rule to transmit the data in field F2 (product name) and field F12 (qualified status) of the product item to the electronic device 30 by the network 20 for subsequent use.

In this embodiment, after receiving the at least a corresponding datum in one of the product items P01 to P12, the electronic device 30 displays the at least a datum on the screen 32 of the electronic device 30. For example, the electronic device displays the data of the product name and the qualified status of the product item P03 on the screen so that workers will be informed whether the product of the product item P03 is qualified or not.

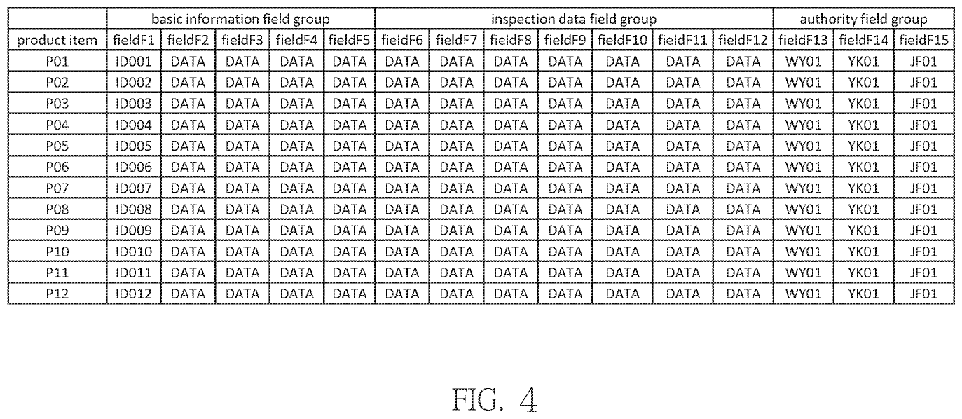

As shown in FIG. 4, the product items P01 to P12 in the database of the second preferred embodiment of the present invention are based on the first preferred embodiment. The field of each of the product items P01 to P12 further includes an authority field group (field F13 to field F15) which is provided for recording the authority data of the product items. For example, field F13 to field F15 are account fields for recording account data which are authorized to access the product items; the effect of the account data will be described later. Moreover, the number of the aforementioned account fields can be one or more than three, in other words, each of the product items P01 to P12 includes one or multiple account data. The account data in the same account field among the product items P01 to P12 can be the same or different.

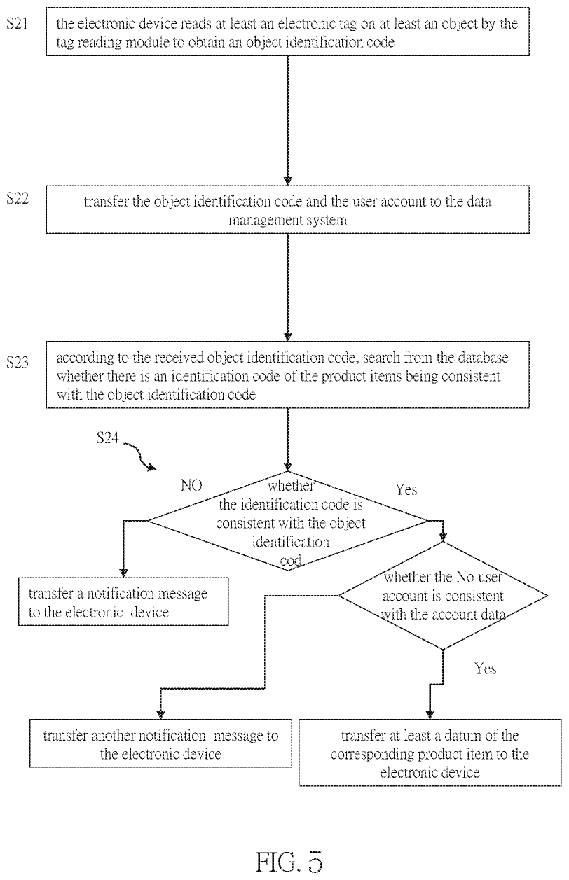

A method of checking products in the second embodiment includes the steps shown in FIG. 5. Steps S21 and S23 are the same as steps S11 and S13 in the first embodiment; steps S22 and S24 are roughly the same as steps S12 and S14 in the first embodiment, while the difference is as follows.

Step S22 further includes the step that the electronic device 30 transmits a user account besides the object identification code to the data management system 100. In this embodiment, a worker enters the user account into the electronic device 30 previously. When transmitting the object identification code, the electronic device 30 transmits the user account to the server 10 as well. In practical, the electronic device 30 can transmit the user account first, and then transmit the object identification code next.

In step S24, if the consistent identification code is found, and besides, the user account is also consistent with at least an account data in the corresponding one of the product items P01 to P12, the data management system 100 transmits the at least a datum to the electronic device 30. In this embodiment, the server 10 finds the product items P01 to P12 corresponding to the identification code form the database 12 first, and then compares the user account with the content of one of the account fields (field F13 to field F15) of the corresponding product items P01 to P12. If the user account is consistent with the content of the one of the account fields, the at least one data of the product items P01 to P12 would be transmitted.

For example, the object identification code is “ID003” and the user account is “WY01”. First, the server 10 finds the corresponding product item P03, and then compares the user account “WY01” with the account data in field F13 “WY01”. Because the user account is consistent with the account data, the server 10 follows the transmission rule to transmit the data in field F2 (product name) and field F12 (qualified status) of the product item P03 to the electronic device 30 through the network for subsequent use, such as displaying on the screen 32.

If the user account is different from the account data of the corresponding product items P01 to P12, the at least one data of the product items P01 to P12 would not be transmitted, and another notification message would be transmitted to the electronic device 30. The another notification message indicates that the object 50 belongs to the product corresponding to the product items P01 to P12 in the database 12; the another notification message can be words like “company product confirmed”. The electronic device 30 can display the another notification message on the screen 32.

By the abovementioned steps, without the user account, workers can still be informed that whether the object 50 belongs to the product owner. On the other hand, with the user account, workers can be authorized to further obtain the data of the product items P01 to P12 corresponding to the object 50.

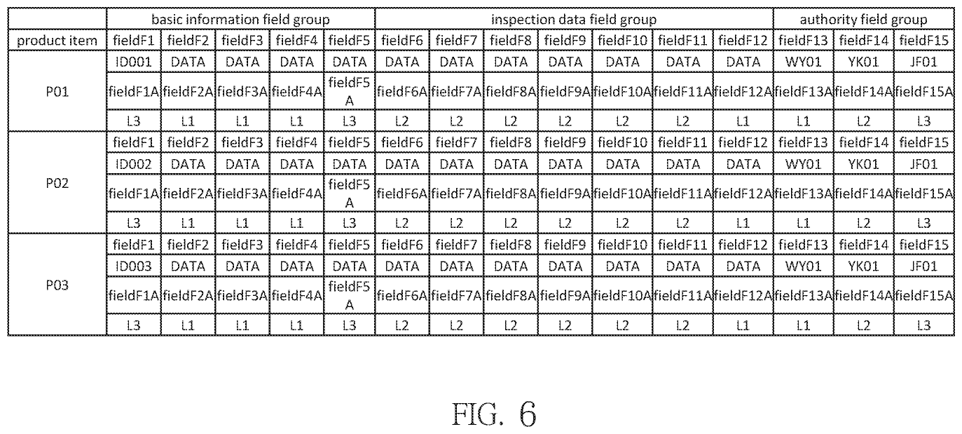

The product items P01 to P03 in the database of the third preferred embodiment of the present invention are shown in FIG. 6; the product items P04 to P12 are omitted. This embodiment is based on the second embodiment. Furthermore, the authority field group of each of the product items P01 to P03 includes a plurality of authority level fields (fields F1A to F15A). Fields F1A to F12A are corresponding to fields F1 to F12 respectively, and are provided for recording the authority level of each of the fields F1 to F12 to be accessed. In other words, each datum of each of the product items P01 to P03 is corresponding to one of the authority levels “L1” to “L3”. Fields F13A to F15A are corresponding to fields F13 to F15 respectively, and are provided for recording the authority level of the account data of the corresponding field F13 to F15 for accessing. In addition, the authority level of the account data of each of the product items P01 to P12 may be different from each other. For easily interpretation, “L1” is the lowest level and “L3” is the highest level.

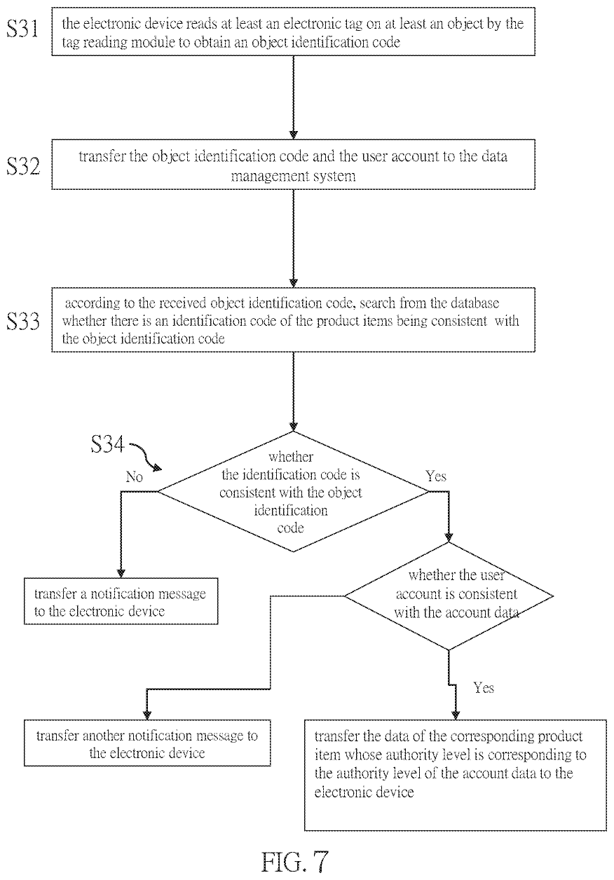

A method of checking products in the third embodiment includes the steps shown in FIG. 7. Steps S31 to S33 are the same as steps S21 to S23 in the second embodiment; step S34 is roughly the same as step S24 in the second embodiment, while the difference is as follows.

Step S34: if the consistent identification code is found, and also, the user account is consistent with the at least an account data in the corresponding one of the product items P01 to P12, then transmit the at least one data of the corresponding one of the product items P01 to P12 whose authority level to be accessed is consistent with the authority level of the account data to the electronic device 30. In this embodiment, the server 10 not only compares the account fields (field F13 to field F15) but finds the authority level of the account data.

Take the found product item P03 and the account data “WY01” as an example, the server 10 obtains that the authority level of the account data “WY01” is “L1”.Additionally, the server 10 finds the content of fields F2A, F3A, F4A, and F12A of the product item P03 is “L1”, and then transmits the data of corresponding fields F2, F3, F4, and F12 (i. e., the data corresponding to level “L1”) to the electronic device 30 for subsequent use, such as displaying on the screen 32.

It could be set that the authority level of the data transmitted by the server 10 is no more than the authority level of the corresponding account data. Take the found product item P03 and the account data “YK01” as an example, the authority level of the account data is “L2”. Moreover, form the field F1A to field F12A of the product item P03,the server 10 finds fields F2A to F4A and F6A to F12A which contain authority levels “L2” or “L1” (lower than “L2”). Afterward, the server 10 transmits the data of the corresponding fields F2 to F4 and F6 to F12 (i. e., the data corresponding to level “L2” and “L1”) to the electronic device 30 for subsequent use.

Similarly, if the found account data is “JF01” whose authority level is the highest, the server 10 then transmits the data of the fields F1 to F12 to the electronic device 30 for subsequent use.

In this embodiment, in the database 12, one of the authority levels to which the account data is corresponding can be defined as a revisable level, and a part of the data of each of the product items P01 to P12 can be set as revisable data. For example, the authority level “L2” is the revisable level, and fields F6 to F12 in the inspection data field group are the revisable fields.

Therefore, after the electronic device 30 transmits the object identification code “ID003” and the user account “YK01” to the data management system 100, the electronic device 30 receives the data of fields F2 to F4 and F6 to F12 of the product item P03. Furthermore, the inspector of the product can revise at least one of the data on the electronic device 30. For example, revise at least one of the data of fields F6 to F12 of the inspection data field group to create at least a revised data, and then transmit the at least a revised data and the user account to the data management system 100.

When the server 10 of the data management system 100 confirms the authority level “L2” of the account data which is consistent with the user account “YK01” is the revisable level, the server 10 of the data management system 100 updates the at least one corresponding data of the product item P03 according to the at least a revised data, i. e., the data of at least one of the fields F6 to F12.

By the abovementioned steps, in the management of data of the product items P01 to P12 in the database 12, different management authority can be given according to different authority levels of the account data.

The methods of checking products in each abovementioned embodiment are also able to apply to any product besides hanging devices as long as there is an electronic tag provided on the product, or an electronic tag embedded into the product or object.

The embodiments described above are only preferred embodiments of the present invention. All equivalent methods which employ the concepts disclosed in this specification and the appended claims should fall within the scope of the present invention.

1. A method of checking products, which is applied to a data management system comprising a database storing a plurality of product items which are corresponding to a plurality of products, wherein each of the plurality of product items has at least a datum and at least an account data and comprises an identification code which is corresponding to one of the plurality of products; the method comprises the steps of:
A. providing an electronic device which is connected to the data management system, wherein the electronic device comprises a tag reading module; the electronic device reads at least an electronic tag on at least an object by the tag reading module so as to obtain an object identification code which is corresponding to and provided on the electronic tag;
B. transmitting the object identification code to the data management system after obtaining the object identification code, which is performed by the electronic device; transmitting a user account to the data management system, which is performed by the electronic device;
C. according to the received object identification code, searching from the database whether an identification code of the product items is consistent with the object identification code, which is performed by the data management system; and
D. if the identification code which is consistent with the object identification code is not found, transmitting a notification message to the electronic device, which is performed by the data management system; if the identification code which is consistent with the object identification code is found, and also, the user account is consistent with the at least an account data of the corresponding one of the product items, then transmitting the at least a datum of one of the product items which is corresponding to the identification code consistent with the object identification code to the electronic device, which is performed by the data management system; if the identification code which is consistent with the object identification code is found, and the user account is different from the at least an account data of the corresponding one of the product items, then transmitting another notification message rather than the at least a datum to the electronic device.

2. The method of claim 1, wherein after step D, further comprising the step of: after the electronic device receives the notification message, displaying the notification message on a screen of the electronic device, which is performed by the electronic device.

3. (canceled)

4. The method of claim 1, wherein after step D, further comprising the step of:
after the electronic device receives the at least a datum of the corresponding one of the product items, displaying the at least a datum on a screen of the electronic device, which is performed by the electronic device.

5. (canceled)

6. (canceled)

7. The method of claim 1, wherein after step D, further comprising the step of:
after the electronic device receives the another notification message, displaying the another notification message on a screen, which is performed by the electronic device.

8. A method of checking products, which is applied to a data management system comprising a database storing a plurality of product items which are corresponding to a plurality of products, wherein each of the plurality of product items has at least a datum and at least an account data and comprises an identification code which is corresponding to one of the plurality of products; the number of the at least an account data of each of the product items is more than one, and the account data have a plurality of different authority levels; the number of the at least a datum of each of the product items is more than one, and each of the data is corresponding to one of the authority levels; the method comprises the steps of:
A. providing an electronic device which is connected to the data management system, wherein the electronic device comprises a tag reading module; the electronic device reads at least an electronic tag on at least an object by the tag reading module so as to obtain an object identification code which is corresponding to and provided on the electronic tag;
B. transmitting the object identification code to the data management system after obtaining the object identification code, which is performed by the electronic device; transmitting a user account to the data management system, which is performed by the electronic device;
C. according to the received object identification code, searching from the database whether an identification code of the product items is consistent with the object identification code, which is performed by the data management system; and
D. if the identification code which is consistent with the object identification code is not found, transmitting a notification message to the electronic device, which is performed by the data management system; if the identification code which is consistent with the object identification code is found, and also, the user account is consistent with the at least an account data of the corresponding one of the product items, then transmitting the at least a datum of one of the product items which is corresponding to the identification code consistent with the object identification code to the electronic device, which is performed by the data management system; transmitting the at least a datum of the corresponding one of the product items whose authority level is consistent with the authority level of the account data to the electronic device.

9. The method of claim 8, wherein in step D, the authority level of the transmitted at least a datum is no more than the authority level of the account data.

10. The method of claim 8, further comprising the step of defining one of the authority levels as a revisable level, and after step D, further comprising the steps of:
revising the at least a datum on the electronic device to create at least a revised data, as well as transmitting the at least a revised data and the user account to the data management system;
when confirming that the authority level of the account data which is consistent with the user account is the revisable level, updating the at least a datum of the corresponding one of the product items according to the at least a revised data, which is performed by the data management system.

11. The method of claim 8, wherein after step D, further comprising the step of: after the electronic device receives the notification message, displaying the notification message on a screen of the electronic device, which is performed by the electronic device.
